(19) United States
(12) Patent Application Publication
(10) Pub. No.: US 2003/0093789 A1
(43) Pub. Date: May 15, 2003

(54) Systems for monitoring broadcast content and generating notification signals as a function of subscriber profiles and methods of operating the same

(76) Inventors: John Zimmerman, Ossining, NY (US); Radu S. Jasinschi, Ossining, NY (US); Lalitha Agnihotri, Fishkill, NY (US)

Correspondence Address: Corporate Patent Counsel, U.S. Philips Corporation, 580 White Plains Road, Tarrytown, NY, 10591, US

(21) Appl. No.: 09/990,830

(22) Filed: Nov. 9, 2001

(51) Int. Cl. H04N 7/025; H04N 7/10; G06F 3/00; H04N 5/445; G06F 13/00; G06F 15/173

(52) U.S. Cl. 725/34; 725/35; 709/224; 725/46

(57) ABSTRACT

There are disclosed systems for monitoring broadcast content and generating notification signals as a function of subscriber profiles and methods of operating the same. According to an exemplary embodiment, a monitoring system is introduced that is capable of identifying special event content within a plurality of broadcast content streams, each of the plurality of broadcast content streams having detectable content attributes. The monitoring system is operable to (i) sense a content change within at least one of the plurality of broadcast content streams as a function of the detectable content attributes, (ii) detect the special event content broadcast within the at least one of the plurality of broadcast content streams as a function of the sensed content change, and (iii) selectively generate a notification signal as a function of the detected special event content and a subscriber profile.

### CROSS-REFERENCE TO RELATED APPLICATION

The present invention is related to those disclosed in U.S. patent application Ser. No. [Docket No. 701481], filed concurrently herewith, entitled “SYSTEMS FOR SENSING SIMILARITY IN MONITORED BROADCAST CONTENT STREAMS AND METHODS OF OPERATING THE SAME.” The above application is commonly assigned to the assignee of the present invention. The disclosure of this related patent application is incorporated by reference for all purposes as if fully set forth herein.

### TECHNICAL FIELD OF THE INVENTION

The present invention is directed, in general, to monitoring broadcast content systems and, more specifically, to systems for monitoring broadcast content and generating notification signals as a function of subscriber profiles and methods of operating the same.

### BACKGROUND OF THE INVENTION

Public alarm and emergency warning systems provide citizens with audible and/or visual signals alerting them to present or impending danger. These systems, which may include sirens as well as radio and television broadcasts, are intended to reach the greatest number of people possible, as quickly as possible.

To improve alarm/warning coverage, the Emergency Broadcast System (EBS) was created during the Cold War. During a federal, state or local emergency, AM and FM radio stations, and broadcast and cable television stations may transmit area-wide emergency messages to receivers in the emergency area. In the case of television, this emergency warning signal may consist of an audible alarm tone, a static alarm symbol, such as tornado funnel cloud or a test pattern, a text message which scrolls across a portion of the television screen, or a live broadcast by, for example, a news reporter.

Over the years, the ever-continuing advancements in technology have necessarily improved public alarm and emergency warning systems. However, problems continue to exist in contacting all individuals within the alarm area, as there is no “guarantee” that everyone within the geographical area of concern will receive the alarm warning.

Audible alarm systems, such as sirens, for instance, are used to notify people within a particular geographic area of the presence of emergency situations that may endanger them, such as tornadoes, fires, toxic hazards, and the like. There may be an insufficient number of sirens to cover a particular area properly, so that some individuals are not close enough to the nearest siren tower to hear the alarm. This is especially true in rural areas. Additionally, some individuals may be inside well-insulated buildings, so that the alarm siren cannot penetrate to their location.

In the case of broadcast alarms, it is likely that many individuals will not have their television or radio turned on when a warning is broadcast. Further exacerbating this problem, the advent of digital television (DTV), the increasing popularity of the Internet, and the introduction of consumer multimedia electronics, such as compact disc (CD) and digital video disc (DVD) players, there is an ever increasing likelihood that individuals will be engaged in using one of the foregoing and not be “tuning in” to a publicly broadcast channel.

An extension of the foregoing deficiencies relates to what can be referred to as the broader and encompassing concept of “special events” or “Live Alerts.” A “special event,” or “Live Alert,” may include, in addition to public alarms and emergency warnings, important local, national, or international events (e.g., political, economic, etc.) . For instance, in the case of the sudden death of a prominent public figure most major television channels, radio stations, Internet sites, etc. will interrupt their regular programming schedule to show or report on the “same” special event.

With the advent of the Internet and the exponential increase in cable, satellite, time-shifted viewing and the like, the viewer is decreasingly exposed to the traditional publicly broadcast television channels (e.g., WABC, WCBS, WNBC, etc.) and therefore to their airing of these special events.

There is a need in the art for improved public alarm/emergency warning systems. In particular, there is a need for improved systems that can reach individuals who may not be tuned in to traditional publicly broadcast channel to inform them of special events, including public alarms and emergency warnings. There is yet a further need for systems that sense special events, including non-public alarm/non-emergency warning-type special events, broadcast within content streams as well as means for communicating select special events to individuals. To that end, there is a need that such systems be capable of discerning differences in “similar” content in multiple broadcast content streams so as to properly filter actual special events from pre-emptive content that initially appears to be a possible special event, but is, in point of fact, not a special event.

### SUMMARY OF THE INVENTION

To address the above-discussed deficiencies of the prior art, it is a primary object of the present invention to provide systems for monitoring broadcast content and generating notification signals as a function of subscriber profiles and methods of operating the same. According to an exemplary embodiment, a monitoring system is introduced that is capable of identifying special event content within a plurality of broadcast content streams, each of the plurality of broadcast content streams having detectable content attributes and being any of television (e.g., traditional, cable, satellite, etc.), radio, Internet or other broadcast content streams.

The monitoring system is operable to (i) sense a content change within at least one of the plurality of broadcast content streams as a function of the detectable content attributes, (ii) detect the special event content broadcast within the at least one of the plurality of broadcast content streams as a function of the sensed content change, and (iii) selectively generate a notification signal as a function of the detected special event content and a subscriber profile.

The broadcast special event content may suitably be indicative of a public alarm, an emergency warning, an event of interest (e.g., local, regional, national or international political, economic, social, government or like event), as well as any event that is of interest to a subscriber, subscriber group or subscriber type, or the like, the latter may be defined, at least in part, by a subscriber profile.

Further, ones of the detectable content attributes, the sensed content changes, detected special event content, and subscriber profiles are processed, at least in part, as a function of associated threshold values that are used to determine whether the same changes are within tolerance (i.e., has not exceeded a threshold). It should be noted that such one or more associated thresholds may be statically or dynamically represented. The sophistication of any such representation may be as complex or as uncomplicated as needed by a given special event detection application are related subscriber profile. It should further be noted that any representation may be set initially to, or reset to, a default setting.

According to an advantageous embodiment hereof, the monitoring system senses content changes in the received broadcast content streams by comparing ones of the detectable content attributes, either with other detectable content attributes, expected content attributes, reference values for the attributes, or the like. For the purposes hereof, the term “sense” and derivatives thereof are defined broadly, meaning to sense one or more values, changes in value, or some combination of the same, of at least the sensed change of the detectable content attributes.

Also according to this embodiment, the monitoring system may be arranged to detect the broadcast special event content using, for instance, one or more of the following techniques, namely, (i) monitoring Emergency Broadcast System (EBS) transmissions, (ii) monitoring broadcast content streams for “attention tones” (e.g., audible tones broadcast before weather banners appear within video data, etc.), (iii) monitoring broadcast content streams “banners” that appear within video data, such as at the top or bottom of display screen, (iv) monitoring broadcast content stream transcripts (e.g., speech to text, closed captions, HTML text, video screen text, etc.) for “key words” such as disaster, emergency, tornado, or the like, (v) monitoring broadcast content streams for emergency graphics, such as a tornado, hazardous-materials, or other like graphic, (vi) monitoring broadcast content streams for special event “locations,” for instance when a weather banner appears, the system looks for international, national, regional, local names, (vii) monitoring broadcast content streams for abnormal or unusual format or format changes which may be indicative of preemption of scheduled broadcast content with unscheduled broadcast content (i.e., “preempt,” and derivatives thereof, as used herein, is defined broadly to mean any unanticipated change or intrusion of content (e.g., audio, video, text, image, etc) into one or more broadcast content streams), (viii) monitoring broadcast content streams for the time duration of any such abnormal or unusual format or format changes, (ix) sensing similarity across several broadcast content streams when such similarity is not expected, and (x) monitoring broadcast content streams for the time duration of any such similarity across several broadcast content streams.

According to this embodiment, the monitoring system computes a value for the detected special event, weighing for instance ones of the above-introduced techniques to determine the importance of a given detected special event. An important aspect of the foregoing is that such implementations are capable of discerning differences in “similar” content across multiple broadcast content streams to allow for proper filtration of “true” special events from other pre-emptive content that initially appears to be a possible special event, but is not a special event.

For example, if it is assumed that the range of values were “0” to “100” with “100” being indicative of highest importance, then, if several broadcast content streams each included substantially similar special event broadcast content, then the monitoring system may suitably compute a value of “70.” Alternatively, if several broadcast content streams each included substantially similar broadcast special event content, and the special event were a tornado and the location were close to the subscriber's residence the computed value may be increased to “80;” if, however, the location were not close to the subscriber residence the computed value may be decreased to “50.”

The monitoring system, upon the detection of the special event, is further operable to selectively generate a notification signal as a function of the detected special event content and a subscriber profile. The phrases “subscriber profile” or “user profile” may be used interchangeably, and broadly mean any data relating to the audience that is or is likely to be viewing, listening or should otherwise be perceiving the special event content at a given time, and may be stored at any one or more of several system components, including, for instance, a remote control, a set top box, a personal digital assistant (PDA), mobile communication device (e.g., pager, cellular telephone, etc.) or in a control database accessible through a communications device.

In a subscriber profile, a subscriber is able to specify information that may suitably be used to determine (i) a level of importance that a detected special event has to the subscriber and (ii) if the level of importance requires the detected special event be communicated to the subscriber, how the subscriber is to be contacted. Exemplary subscriber information that may suitably be included in a profile includes (i) subscriber's address(es), (ii) subscriber's telephone number(s), (iii) subscriber's email address(es), (iv) subscriber's interests (e.g., China, painting, beach recreation, professional football, etc.), (v) subscriber emergencies/warnings of interest (e.g., tornadoes, terrorists, hurricanes, floods, etc.), and (vi) preferences for contacting the subscriber in the event of a special event of interest (e.g., during late evenings/early morning, turn “ON” select appliances if a select special event scores above an “80;” during daytime, dispatch a wireless message to at least one communication device associated with the subscriber/user if a select special event scores above an “85” or if a select special event scores above an “60” and the special event is a tornado, etc.).

Importantly, monitoring system-to-subscriber communications in accordance with the present invention may be “personalized” for particular individuals/users. In point of fact, the possible permutations and level of communication preferences is near endless, though all remain within the scope of the present invention. A further aspect hereof is that special events may be detected as a function of content sensed within a first segment of one received broadcast content stream and a second segment of the same received broadcast stream (i.e., temporally disparate), as well as with a second segment of another of the received broadcast streams.

The foregoing has outlined rather broadly the features and technical advantages of the present invention so that those skilled in the art may better understand THE DETAILED DESCRIPTION OF THE INVENTION that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the terms “controller” and “processor” mean any device, system or part thereof that controls at least one operation, such a device may be implemented in hardware, firmware or software, or some combination of at least two of the same. It should be noted that the functionality associated with any particular controller/processor may suitably be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a block diagram of an exemplary PRIOR ART Emergency Broadcast System (EBS) with which the principles of the present invention may suitably be associated;

FIG. 2 illustrates a detailed block diagram of an exemplary monitoring system in accordance with one embodiment of the present invention;

FIG. 3 illustrates a block diagram of an exemplary appliance operable to identify special event content within the segments of one or more broadcast content streams in accordance with one embodiment of the present invention; and

FIG. 4 illustrates a flow chart of an exemplary method of operating a monitoring system for identifying select special event broadcast content within the segments of one or more broadcast content streams and then generating a notification signal to a subscriber in accordance with one embodiment of the present invention.

### DETAILED DESCRIPTION OF THE INVENTION

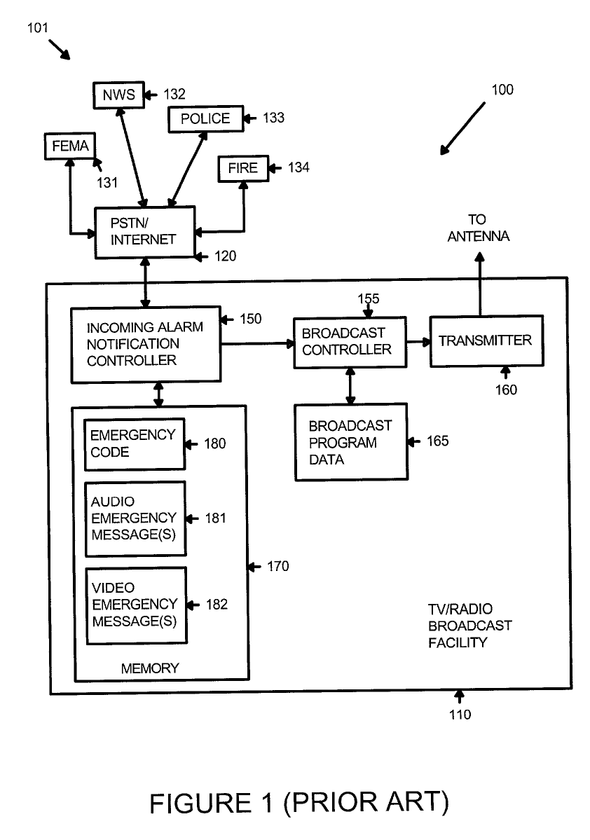

FIG. 1 illustrates a block diagram of an exemplary PRIOR ART broadcast system (generally designated 100) that includes an exemplary Emergency Broadcast System (EBS, generally designated 101) with which the principles of the present invention may suitably be associated. EBS 101 is provided for purposes of illustration only and it is understood that a special event (or “Live Alert”) may include emergency broadcasts associated with broadcast content streams, as well as any other local, regional, national or international event. To that end, a “special event,” as the phrase is used herein, is defined broadly as any public alarms and emergency warnings, local, regional, national, or international events (e.g., political, economic, social, government, etc.), or any event that is of interest to a subscriber, subscriber group or subscriber type, or the like in accord with the principles of the present invention.

Exemplary broadcast system 100 also comprises public switched telephone network (PSTN)/Internet 120 which transfers emergency warning signals from public safety agencies of EBS 101 to a television (TV)/radio broadcast facility 110. Public safety agencies may include Federal Emergency Management Agency (FEMA) 131, National Weather Service (NWS) 132, police service 133, and fire service 134. Exemplary TV/radio broadcast facility 110 comprises incoming alarm notification controller 150, broadcast controller 155, transmitter 160, broadcast program data 165, and memory 170.

In operation, broadcast controller 155 enables the transfer of broadcast content (or program data) 165 to transmitter 160. The broadcast content commonly includes scheduled or programmed content broadcast over a plurality of channels (e.g., television, radio, Internet, etc.), and occasionally includes unscheduled or preemptive content that is broadcast over at least one of the channels when scheduled or programmed content is to be broadcast.

In some situations, this unscheduled or preemptive content may be in the form of a “breaking news” interruption during an otherwise scheduled program, a special event indicator like a text-line “ticker” associated with a broadcast program, or an alarm notification. For instance, incoming alarm notification controller 150 may receive one or more alarm notifications from one or more of FEMA 131, NWS 132, police service 133, and fire service 134 via PSTN/Internet 120 and, in response thereto, causes an alarm message to be transferred to broadcast controller 155 when an alarm is present.

Again, under normal (non-emergency) operating conditions, broadcast controller 155 enables the transfer of broadcast content or program data 165 to transmitter 160. However, when broadcast controller 155 detects the presence of an alarm condition from incoming alarm notification controller 150, broadcast controller 155 causes the indicated alarm message to be transferred to transmitter 160. Transmitter 160 is a conventional transmitter that converts a normal broadcast program or alarm message signals from broadcast controller 155 to a suitable frequency and power level for output to receivers throughout the broadcast area. In the case of a cable station, transmitter 160 may be coupled to a cable network, rather than to a transmission antenna.

Regardless, broadcast program data 165 provides standard non-emergency program data for output to broadcast controller 155. Broadcast program data 165 may comprise “live” programs, such as news, sports or the like, or pre-recorded programs, such as music, television movies, situation comedies (sitcoms) or the like. Broadcast program data 165 may be provided by a local source, such as a news studio, or by a remote source, such as a network feed.

Memory 170 provides storage for an application program executed by incoming alarm notification controller 150, as well as storage for emergency code 180, audio emergency message(s) 181, and video emergency message(s) 182. Emergency code 180 represents the portion of memory 170 which is allocated for the storage of one or more emergency code(s) associated with the EBS message(s) received by incoming alarm notification controller 150. Typically, emergency code 180 stores a single code though additional codes may be provided.

Audio emergency message(s) 181 stores one or more audio emergency message(s) associated with the received alarm signal. The audio message(s) may be pre-recorded for each expected alarm type or may be received via PSTN/Internet 120 from one or more of FEMA 131, NWS 132, police service 133, and service fire 134. Similarly, video emergency message(s) 182 stores one or more video emergency message(s) associated with the received EBS alarm signal. These video messages may be pre-recorded for each expected alarm type or may be received via PSTN/Internet 120 from one or more of FEMA 131, NWS 132, police service 133, and service fire 134. Video emergency message(s) 182 is used for the broadcast signals output by broadcast facility 110.

Under normal operating conditions, broadcast facility 110 transmits regularly scheduled television or radio programs provided by broadcast program data 165. When incoming alarm notification controller 150 detects the presence of an alarm from PSTN/Internet 120, incoming alarm notification controller 150 may completely or partially interrupt the normal broadcast and cause one or more of emergency code 180, audio emergency message(s) 181 or video emergency message(s) 182 to be transmitted by broadcast facility 110. This interruption may be in the form of a complete interruption of a scheduled program, or the association of a rolling “ticker” text message with the continued broadcast of the scheduled content, for instance. After a pre-determined time under program control or station control, incoming alarm notification controller 150 enables broadcast controller 155 to again output the normally scheduled broadcast program.

It should be noted again, that in addition to such more traditional special events, namely, public alarms and emergency warnings, the preemptive broadcast content may also be any local, regional, national, international or like events, as well as any event that is of interest to a subscriber, subscriber group or subscriber type, or the like in accord with the principles of the present invention.

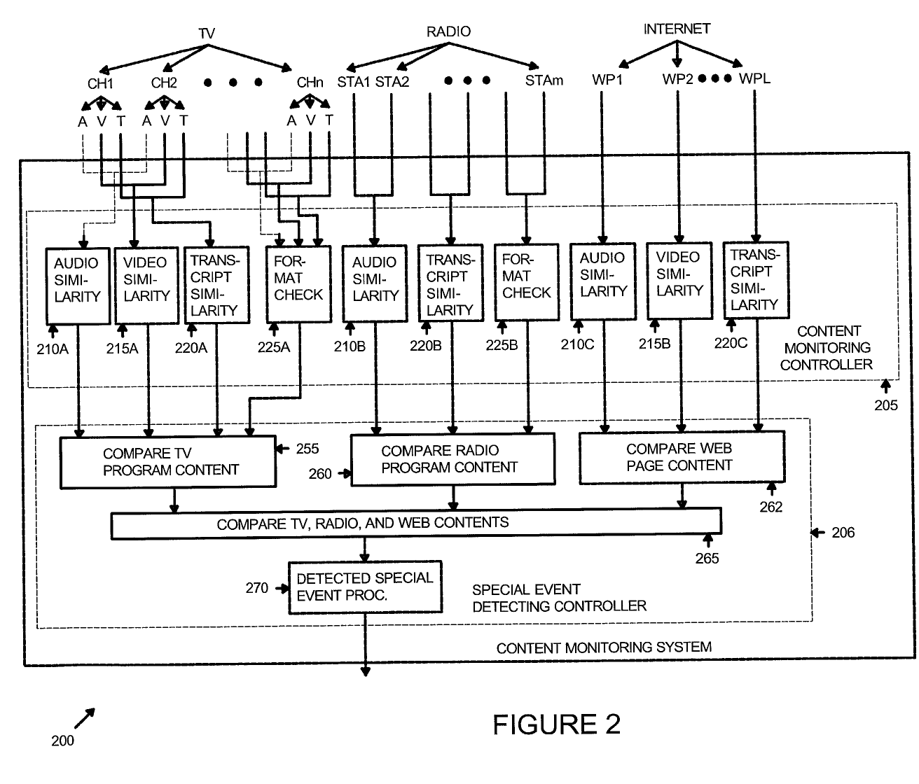

FIGS. 2 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged content broadcast system.

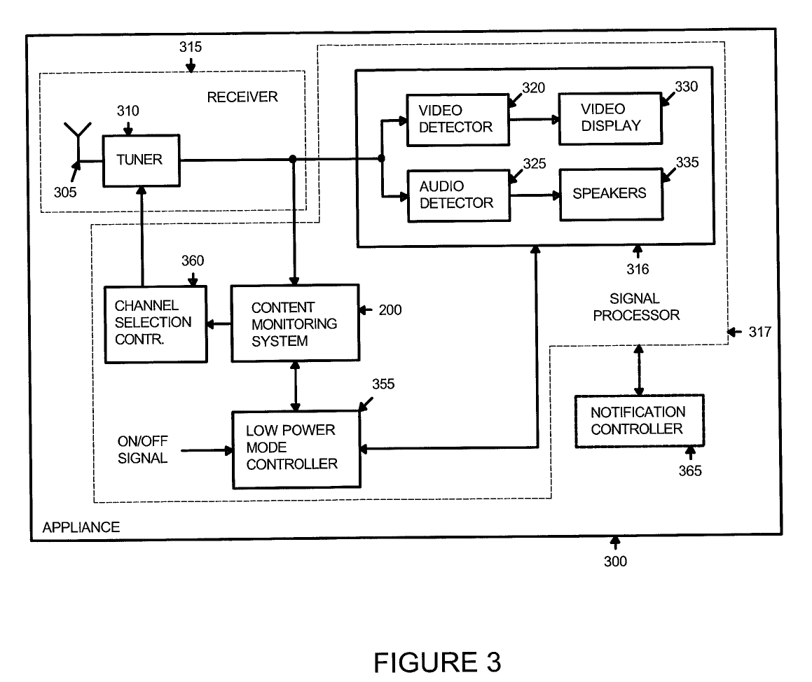

FIG. 2 illustrates a detailed block diagram of an exemplary content monitoring system (generally designated 200) in accordance with one embodiment of the present invention. Exemplary content monitoring system 200 is provided for use in an appliance (shown in FIG. 3; e.g., television, set-top box, computer (e.g., handheld, laptop, desktop, computer network, etc.), or the like) comprising a receiver capable of receiving broadcast content streams. Broadly, content monitoring system 200 operates to monitor a plurality of broadcast streams (e.g. channels, stations, etc.) and, in response to sensing changes in broadcast content, to identify special event content broadcast within segments at least one such monitored broadcast stream as a function of detectable content attributes and at least one subscriber profile. A related invention is set forth and disclosed in co-pending U.S. patent application Ser. No. [Docket No. 701481], filed concurrently herewith, entitled “SYSTEMS FOR SENSING SIMILARITY IN MONITORED BROADCAST CONTENT STREAMS AND METHODS OF OPERATING THE SAME,” and previously incorporated by reference for all purposes as if fully set forth herein.

The ability to sense changes generally in broadcast content is known in the art. The deficiencies of the art are found in identifying “select” sensed content changes, which, according to the present invention, is accomplished as a function of detected content attributes. Content attributes may be detected directly from the monitored broadcast channels (e.g., cut rates, color histograms, motion data, object data, sound effects, speech patterns, noise patterns, music patterns, speech-to-text translation data (whether in summarized form or otherwise), closed-caption data, embedded-text data, video-screen-text data, etc.), or indirectly from any suitable data repository, select data retrieved over the Internet or the like, including, for instance, some metadata.

Content monitoring system 200 comprises a content monitoring controller 205 and a special event detecting controller 206. Broadly, exemplary content monitoring controller 205 monitors the plurality of broadcast content streams. Content monitoring controller 205 is more specifically operable to (i) receive the plurality of broadcast content streams from at least one receiver, (ii) monitor the plurality of received broadcast content streams, and (iii) sense content changes in the plurality of received broadcast content streams as a function of the detectable content attributes.

Exemplary special event detecting controller 206 broadly processes the sensed content changes, comparing a first segment and a second segment of at least one broadcast content stream to identify special event broadcast content within the segments as a function of ones of sensed content changes and to selectively generate a notification signal as a function of the detected special event content and a subscriber profile. Special event detecting controller 206 is more specifically operable to identify a defined set of select broadcast content as a function of ones of the detectable content attributes associated with the sensed changes of the select broadcast content and subscriber profile, along with one or more threshold values associated with the same.

According to the illustrated embodiment, special event detecting controller 206 identifies the defined set of select broadcast content as unscheduled broadcast content that preempts scheduled broadcast content (e.g., distinguishing between normal and preempting content changes, and, when a preempting content change is identified, to determine whether the preempting content change is tolerable or within tolerance—a local weather event, a Presidential race, a terrorist act, a major sporting event, etc.).

More particularly, content monitoring controller 205 illustratively comprises audio similarity processors 210A to 210C, video similarity processors 215A to 215B, transcript similarity processors 220A to 220C, and format-check similarity processors 225A to 225B. Special event detecting controller 206 illustratively comprises a compare television program content processor 255, a compare radio program content processor 260, a compare web page content processor 262, a compare television, radio and Internet program content processor 265, and a detected special event processor 270.

According to the illustrated embodiment, monitoring system 100 is capable of identifying special event content within a plurality of broadcast content streams (e.g., television channels, radio stations, Internet websites, etc.). Exemplary audio similarity processors 210A to 210C, video similarity processors 215A to 215B, transcript similarity processors 220A to 220C, and format-check similarity processors 225A to 225B respectively receive broadcast content streams television channels CH1 to CHn, radio stations STA1 to STAn, and Internet websites WP1 to WPn, though other sources of broadcast content are possible and within the scope this invention. Audio similarity processors 210A to 210C, video similarity processors 215A to 215B, transcript similarity processors 220A to 220C, and format-check similarity processors 225A to 225B operate to monitor these received broadcast content streams and sense content changes therein as a function of the detectable content attributes.

Exemplary content monitoring controller 205 may suitably employ the following exemplary sensing methodologies, including:

Monitor audio of broadcast content streams for emergency broadcast tone, for instance, for a local emergency, broadcasters often play this tone before important information is transmitted.

Monitor television broadcast for a “ticker” at the bottom of the screen. A ticker is an area where scrolling text often appears. Television broadcasters use this as a method of passing on important information (e.g., thunderstorm warnings, tornado watch, etc.) without preempting the currently broadcast show.

Monitor transcript of a “ticker” for words such as warning, emergency, danger, disaster, etc.

Convert broadcast audio to text and monitor for keywords such as “warning, ” “emergency,” “danger,” “disaster,” etc., to determine if a suspected preempted show is important enough to interrupt viewers.

Monitor closed caption or other text services for words such as “warning,” “emergency,” “danger,” “disaster,” etc., to determine if a suspected preempted show is important enough to interrupt viewers.

Monitor for absence of closed captioning or other text services in content that usually has text, as closed captioning currently is only available for either recorded programs or planned live broadcasts such as scheduled news show and sporting events, when a breaking news story preempts a regularly scheduled shows, the closed caption data is usually not available.

Monitor video, audio, and transcript for a high rate of content repetition, when important events happen, commentators restate the situation frequently to bring viewers who are just tuning in up to speed.

Monitor the format of a broadcast content stream and check to see if it matches the expected format for either the content scheduled in the EPG or for the show previously broadcast on this day and time. Checking this information can help determine if a content scheduled has been preempted, as preempting often indicates a significant event. The format may include, for instance, the following:

Time spacing pattern commercials appearing within the program. When important events happen, the commercial breaks often decrease or are eliminated.

A super-histogram is a chart of color information within a show. Most shows have a distinctive look that creates a unique super-histogram. The system can also check to see if the current super-histogram matches super-histograms of other significant events.

Most shows have a fairly consistent cut rate or pattern of edits throughout the show. Noticing a change, especially a large reduction in the cuts can help determine if a show has been preempted.

Most scheduled shows have a fairly consistent content from broadcast to broadcast that is capable of be sensed. Detecting a change, especially an abrupt change, such as would occur between a scheduled situation comedy (e.g., sitcom) and a preempting news bulletin, can help determine if a show has been preempted.

An important aspect hereof is that each broadcast content stream is format checked, enabling all three modalities to be check against expected format for the program aired. For instance, if commercials are usually aired (commercial broadcasts are expected) and are not being aired currently, or if closed captioning (CC) is usually aired (CC expected) and is not present currently, then one or both of these facts, taken together, may be indicative of similar content representing a special event.

Exemplary special event detecting controller 206, in response to the foregoing analysis, is operable to compare segments of the received broadcast content streams to identify special event content within the segments as a function of ones of the sensed content changes. According to the present embodiment, exemplary compare television program content processor 255, compare radio program content processor 260, and compare web page content processor 262 respectively operate to compare segments of the received broadcast television content streams, segments of the received broadcast radio content streams, and the received web pages content as a function of ones of the sensed content changes. Compare television, radio and Internet program content processor 265 then compares the received broadcast television, radio and Internet content.

Thus, according to the present embodiment, audio, video and transcript content from separate sources (e.g., channels, stations, websites, etc.) are processed and compared first according to like-“type” before processing and comparing the foregoing in total in compare television, radio and Internet program content processor 265. To continue with the “formatting” example above-introduced, unexpected formatting within one or more broadcast content streams may suitably be processed along with audio, video and transcript matches to determine if multiple broadcast content streams are transmitting similar content indicative of a special event.

Broadly, therefore, special event detecting controller 206 operates to identify defined sets of select broadcast content as unscheduled broadcast content that preempts scheduled broadcast content (e.g., distinguishing between normal and preempting content changes, and, when a preempting content change is identified, to determine whether the preempting content change is tolerable or within tolerance—a local weather event, a Presidential race, a terrorist act, a major sporting event, etc.) thereby enabling monitoring system 200 to verify the presence of a special event or “Live Alert.”

Once the special event is detected, comparing a content change sensed between a first segment of one received broadcast content stream and a second segment of either the same or on another one of the broadcast content streams, special event detecting controller 206 may selectively generate a notification signal as a function of the detected special event content and a subscriber profile (i.e., data relating to the audience that is or is likely to be viewing, listening or should otherwise be perceiving the special event content at a given time).

According to this embodiment, the subscriber profile may suitably be used to determine (i) a level of importance that a detected special event has to the subscriber and (ii) if the level of importance requires the detected special event be communicated to the subscriber (preferably accomplished using one or more threshold tests), how the subscriber is to be contacted. Broadly, monitoring system-to-subscriber communications in accordance with the present invention may be “personalized” for particular individuals/users and the possible permutations and level of communication preferences is near endless, though all remain within the scope of the present invention.

FIG. 3 illustrates an exemplary appliance 300 which is operable to identify select special event broadcast content within the segments of one or more broadcast content streams in accordance with one embodiment of the present invention. For the purposes of simplicity in explaining the operation of the present invention, the description that follows is directed toward an embodiment in which the present invention is implemented in a television 300. However, this is by way of illustration only. It should be clearly understood that the present invention may be implemented in any device that includes at least one of a radio, a television, an Internet, or like receiver, including, for example, a television set, a stereo system, a conventional AM/FM radio, set-top box for association with a television, a personal computer (PC) equipped with an tuner card/modem capable of receiving radio, television, Internet or other broadcast content streams among other devices.

Exemplary television 300 comprises a receiver 315, a signal processor 317 and a notification controller 365. Exemplary receiver 315 may be any device operable to receive broadcast content, whether radio, Internet, television (e.g., standard, satellite, cable, etc.) or otherwise. For purposes of illustration, receiver 315 includes an antenna 305 and a tuner 310. Exemplary signal processor 317 comprises an intermediate frequency standby mode circuitry 316, a content monitoring system 200, a low power mode controller 355, and a channel selection controller 360. Exemplary notification controller 365 is operable to provide notification indicia to a subscriber of a special event, and may suitably include an audio indicator (e.g., speaker, siren, etc.), a visual indicator (e.g., light, LED display, etc.), a means for communicating the occurrence of a special event to the subscriber via a communication device (e.g., pager, cellular telephone, Web-enabled PDA or other suitable mobile device, etc.), or the like. According to this embodiment, television 300 is capable of operating in an active mode and a standby mode, the standby mode may advantageously operate in low-power consumption.

Under normal operating conditions, the ON/OFF status of television 300 is controlled by an operator using either a remote control or a manual switch to generate an ON/OFF signal that controls low power mode controller 355. Except for standby mode circuitry 316, the indicated circuits of television 300 operate and receive electrical power when power has been disabled (i.e., placed in the standby mode by enabling the “OFF” signal through the ON/OFF switch).

Antenna 305 receives broadcast content streams from television broadcast stations, radio broadcast stations, Internet Websites, and the like. Antenna 305 transfers these broadcast content streams to tuner 310. Even when television 300 is in standby mode, tuner 310 down converts select frequency channels of the received broadcast content stream to video, audio and other signals that are processed in standby mode circuitry 316 and monitored by content monitoring system 200. With respect to data received via the Internet, the broadcast content stream is received as data packets.

Standby mode circuitry 316 comprises the portions of television 300 that are required for the video and audio conversion of received signals. Standby mode circuitry 316 includes video detector 320, audio detector 325, video display 330, and speakers 335. Video detector 320 and audio detector 325 convert the baseband signals to video signals and audio signals that are sent to video display 330 and audio speakers 335, respectively. Video display 330 provides means for viewing the received broadcast image(s) and speakers 335 provide the audio output associated with the received signals. In an alternate radio embodiment of the present invention, standby mode circuitry 316 may only comprise audio circuits providing the functions of a radio receiver.

The ON/OFF status of standby mode circuitry 316 is controlled by low power mode controller 355. Standby mode circuitry 316 is fully “ON” or operational when low power mode controller 255 is enabled by the ON/OFF switch or by content monitoring system 200 upon detection of select special event broadcast content. Otherwise, standby mode circuitry 316 is in the “OFF” (or standby) mode.

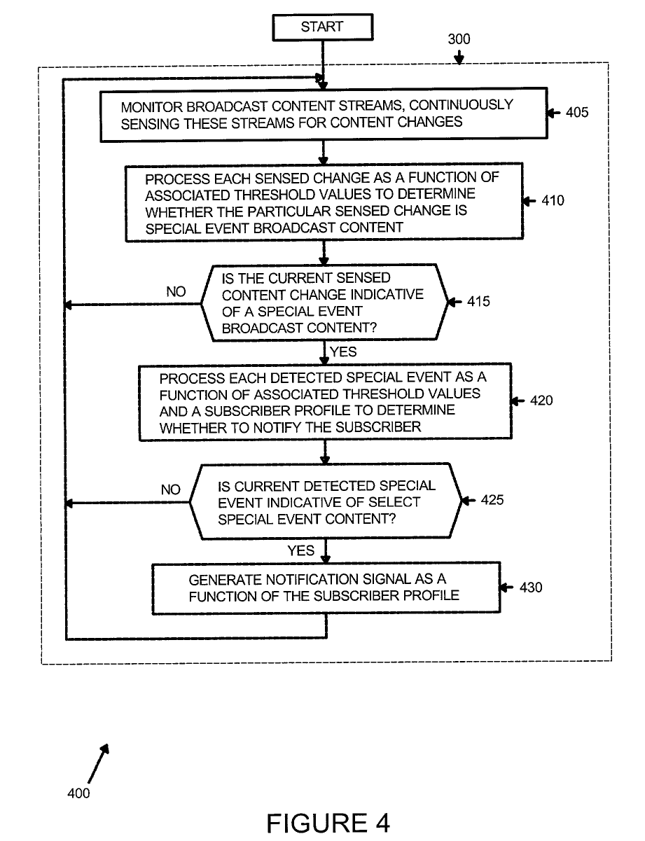

FIG. 4 illustrates a flow chart of an exemplary method (generally designated 400) of operating content monitoring system 200 in accordance with one embodiment of the present invention. For purposes of illustration, the discussion of FIG. 4 is made with concurrent reference to FIGS. 2 and 3 (it is apparent to those skilled in the art that the introduction of a multi-mode appliance 300 is illustrative of one advantageous embodiment of the present invention).

In operation, monitoring system 205 operates to repeatedly sense change in the detectable content attributes of received broadcast content streams (process step 405). More specifically, audio similarity processors 210A to 210C, video similarity processors 215A to 215B, transcript similarity processors 220A to 220C, and format-check similarity processors 225A to 225B receive the plurality of broadcast content streams (e.g., television, radio, Internet, etc.). Audio similarity processors 210A to 210C, video similarity processors 215A to 215B, transcript similarity processors 220A to 220C, and format-check similarity processors 225A to 225B monitor and sense content changes in the received broadcast content streams as a function of the detectable content attributes as described hereinabove.

Special event detecting controller 206 operates to process each sensed change as a function of comparing ones of the detectable content attributes with associated threshold values to determine whether a particular sensed change is special event broadcast content (process step 410). More specifically, compare television program content processor 255, compare radio program content processor 260, compare web page content processor 262, and compare television, radio and Internet program content processor 265 illustratively operate to cooperatively compare temporally disparate segments within a single broadcast stream as well as segments within multiple broadcast streams to identify special event broadcast content within the segments as a function of ones of the detectable content attributes and related threshold values.

According to this embodiment, ones of the sensed changes are processed as a function of associated threshold values to determine whether the change is within tolerance (i.e., has not exceeded a threshold). It should be noted that the one or more associated thresholds may be statically or dynamically represented. The sophistication of any such representation may again be as complex or as uncomplicated as needed by a given application. It should further be noted that any representation may be set initially to, or reset to, a default value.

If special event detecting controller 206 determines that a particular content change is special event broadcast content (“Y” branch of determination step 415), then it is further operable to determine whether to generate a notification signal as a function of the detected special event content and a subscriber profile.

A subscriber is able to specify information that may suitably be used to determine (i) a level of importance that a detected special event has to the subscriber and (ii) if the level of importance requires the detected special event be communicated to the subscriber, meaning how the subscriber is to be contacted. Importantly, monitoring system-to-subscriber communications in accordance with the present invention may be “personalized” for particular individuals/users.

Special event detecting controller 206 operates to process detected special event content as a function of comparing ones of the detectable content attributes with associated threshold values and a subscriber profile to determine whether a particular detected special event includes select special event content requiring communication to the subscriber (process step 420). More specifically, detected special event processor 270 processes the detected special event and upon a determination that the detected special event includes select special event content for communication to the subscriber (“Y” branch of determination step 415), it is further operable to selectively generate a notification signal as a function of the a subscriber profile (process step 430).

In operation, special event detecting controller 206 identifies the defined set of select broadcast content as unscheduled broadcast content that preempts scheduled broadcast content. Again, monitoring system 100 may be arranged to detect the broadcast special event content using, for instance, one or more of the following techniques, namely, (i) monitoring Emergency Broadcast System (EBS) transmissions, (ii) monitoring broadcast content streams for “attention tones” (e.g., audible tones broadcast before weather banners appear within video data, etc.), (iii) monitoring broadcast content streams “banners” that appear within video data, such as at the top or bottom of display screen, (iv) monitoring broadcast content stream transcripts (e.g., speech to text, closed captions, HTML text, video screen text, etc.) for “key words” such as disaster, emergency, tornado, or the like, (v) monitoring broadcast content streams for emergency graphics, such as a tornado graphic, (vi) monitoring broadcast content streams for special event “locations,” for instance when a weather banner appears, the system looks for international, national, regional, local names, (vii) monitoring broadcast content streams for abnormal or unusual format or format changes which may be indicative of preemption of scheduled broadcast content with unscheduled broadcast content, (viii) monitoring broadcast content streams for the time duration of any such abnormal or unusual format or format changes, (ix) sensing similarity across several broadcast content streams when such similarity is not expected, and (x) monitoring broadcast content streams for the time duration of any such similarity across several broadcast content streams.

According to this embodiment, the monitoring system computes a value for the detected special event, weighing for instance ones of the above-introduced techniques to determine the importance of a given detected special event. For example, if it is assumed that the range of values were “0” to “100” with “100” being indicative of highest importance, then, if several broadcast content streams each included substantially similar special event broadcast content, then the monitoring system may suitably compute a value of “70.” Alternatively, if several broadcast content streams each included substantially similar broadcast special event content, and the special event were a school shooting and the location were at the subscriber's children's school the computed value may be increased to “100;” if, however, the location were close to the subscriber's residence but the subscriber did not have children the computed value may be decreased to “60.”

The monitoring system, upon the detection of the select special event having the computed value of “100,” for instance, selectively generates a notification signal as a function of the detected special event content and a subscriber profile (specifying (i) a level of importance that a detected special event has to the subscriber and (ii) how the subscriber is to be contacted).

Again, the subscriber profile may include preferences for contacting the subscriber in the event of a special event of interest (e.g., during late evenings/early morning, turn “ON” select appliances if a select special event scores above an “80;” during daytime, dispatch a wireless message to at least one communication device associated with the subscriber/user if a select special event scores above an “85” or if a select special event scores above an “60” and the special event is a tornado, etc.).

Assuming that it is during late evening or early morning, a threshold-exceeding special event/“Live Alert” is sensed, then if appliance 300 is in “On” mode, communication of the select special event content may be communicated by simply changing a television channel, turning up the volume, or the like. If appliance 300 is in “Off” or standby/low power mode, special event detecting controller 206 causes appliance 300 to switch from standby to the operational or “ON” mode. According to the present example, channel selection controller(s) 360 associated with special event processor 270 may cause appliance 300 to tune to a default or selected emergency channel. Optionally, channel selection controller 360 may cause the tuner to set the volume of the radio or television to a “HIGH” level for emergency notification purposes. Optionally, appliance 300 may be caused to play or display (as applicable) a prerecorded or transmitted audio or video message(s) associated with the detected “Live Alert.”

To reiterate, ones of the detectable content attributes, the sensed content changes, detected special event content, and subscriber profiles are processed, at least in part, as a function of associated threshold values that are used to determine whether the same change are within tolerance (i.e., has not exceeded a threshold). It should be noted that such one or more associated thresholds may be statically or dynamically represented. The sophistication of any such representation may be as complex or as uncomplicated as needed by a given special event detection application or related subscriber profile. It should further be noted that any representation may be set initially to, or reset to, a default setting.

Although the present invention has been described in detail, those skilled in the art should understand that they can make various changes, substitutions and alterations herein without departing from the spirit and scope of the invention in its broadest form.

What is claimed is:

1. A monitoring system capable of identifying special event content within a plurality of broadcast content streams, each of said plurality of broadcast content streams having detectable content attributes, said monitoring system operable to (i) sense a content change within at least one of said plurality of broadcast content streams as a function of said detectable content attributes, (ii) detect said special event content broadcast within said at least one of said plurality of broadcast content streams as a function of said sensed content change, and (iii) selectively generate a notification signal as a function of said detected special event content and a subscriber profile.

2. The monitoring system capable of identifying special event content within a plurality of broadcast content streams as set forth in claim 1 wherein said subscriber profile is stored in memory and comprises at least one record that maintains at least one measurable characteristic of an associated subscriber.

3. The monitoring system capable of identifying special event content within a plurality of broadcast content streams as set forth in claim 2 wherein said stored subscriber profile is initially set as a default profile.

4. The monitoring system capable of identifying special event content within a plurality of broadcast content streams as set forth in claim 2 wherein said monitoring system is further operable to update said stored subscriber profile.

5. The monitoring system capable of identifying special event content within a plurality of broadcast content streams as set forth in claim 2 wherein said subscriber profile provides a mathematical representation of a notification preference of an associated subscriber.

6. The monitoring system capable of identifying special event content within a plurality of broadcast content streams as set forth in claim 5 wherein said subscriber profile is automatically generated by said monitoring system at definition and includes a default notification preference that is modifiable by said associated subscriber.

7. The monitoring system capable of identifying special event content within a plurality of broadcast content streams as set forth in claim 5 wherein said monitoring system, as a function of said mathematical representation of said notification preference, generates said notification signal to selectively direct at least one of a plurality of communication units to communicate a message to said associated subscriber.

8. The monitoring system capable of identifying special event content within a plurality of broadcast content streams as set forth in claim 1 further comprising a content monitoring controller that is operable to (i) receive said plurality of broadcast content streams from at least one receiver, (ii) monitor said plurality of received broadcast content streams, and (iii) sense content changes in said plurality of received broadcast content streams as a function of said detectable content attributes.

9. The monitoring system capable of identifying special event content within a plurality of broadcast content streams as set forth in claim 1 further comprising a special event detecting controller that identifies special event content as a function of said sensed content change, said content detecting controller operable to direct at least one of a plurality of communication units to communicate a message to an associated subscriber as a function of said notification signal.

10. The monitoring system capable of identifying special event content within a plurality of broadcast content streams as set forth in claim 9 wherein said special event detecting controller is further operable to identify said sensed content change as one of scheduled broadcast content and unscheduled broadcast content that preempts scheduled broadcast content.

11. The monitoring system capable of identifying special event content within a plurality of broadcast content streams as set forth in claim 1 wherein said monitoring system is further operable to monitor at least one of audio content, video content and textual content within said plurality of broadcast content streams.

12. The monitoring system capable of identifying special event content within a plurality of broadcast content streams as set forth in claim 11 wherein said monitoring system detects said special event content broadcast within said at least one of said plurality of broadcast content streams as a function of said at least one of audio content, video content and textual content.

13. The monitoring system capable of identifying special event content within a plurality of broadcast content streams as set forth in claim 11 wherein ones of said detectable content attributes include a transcript of said at least one of audio content, video content and textual content, and monitoring system detects said special event content broadcast within said at least one of said plurality of broadcast content streams as a function of said transcript.

14. A method of operating a monitoring system that is capable of identifying special event content within a plurality of broadcast content streams, each of said plurality of broadcast content streams having detectable content attributes, said method of operation comprising the steps of:
sensing a content change within at least one of said plurality of broadcast content streams as a function of said detectable content attributes;
detecting said special event content broadcast within said at least one of said plurality of broadcast content streams as a function of said sensed content change; and
selectively generating a notification signal as a function of said detected special event content and a subscriber profile.

15. The method of operating the monitoring system as set forth in claim 14 wherein said subscriber profile is stored in memory and comprises at least one record that maintains at least one measurable characteristic of an associated subscriber.

16. The method of operating the monitoring system as set forth in claim 15 wherein said stored subscriber profile is initially set as a default profile.

17. The method of operating the monitoring system as set forth in 15 wherein said monitoring system is further operable to update said stored subscriber profile.

18. The method of operating the monitoring system as set forth in claim 15 wherein said subscriber profile provides a mathematical representation of a notification preference of an associated subscriber.

19. The method of operating the monitoring system as set forth in claim 18 wherein said subscriber profile is automatically generated by said monitoring system at definition and includes a default notification preference that is modifiable by said associated subscriber.

20. The method of operating the monitoring system as set forth in claim 18 further comprising the step of generating, as a function of said mathematical representation, said notification signal to selectively direct at least one of a plurality of communication units to communicate a message to said associated subscriber.

21. The method of operating the monitoring system as set forth in claim 14 further comprising the steps of:
receiving said plurality of broadcast content streams from at least one receiver; and
monitoring said plurality of received broadcast content streams.

22. The method of operating the monitoring system as set forth in claim 14 further comprising the step of directing at least one of a plurality of communication units to communicate a message to an associated subscriber as a function of said notification signal.

23. The method of operating the monitoring system as set forth in claim 21 further comprising the step of identifying said sensed content change as one of scheduled broadcast content and unscheduled broadcast content that preempts scheduled broadcast content.

24. The method of operating the monitoring system as set forth in claim 14 further comprising the step of monitoring at least one of audio content, video content and textual content within said plurality of broadcast content streams.

25. The method of operating the monitoring system as set forth in claim 24 wherein said step of detecting said special event content broadcast within said at least one of said plurality of broadcast content streams is as a function of said at least one of audio content, video content and textual content.

26. The method of operating the monitoring system as set forth in claim 24 wherein ones of said detectable content attributes include a transcript of said at least one of audio content, video content and textual content, and said step of detecting said special event content broadcast within said at least one of said plurality of broadcast content streams is as a function of said transcript.

27. An appliance comprising:
a receiver capable of receiving broadcast content streams; and
a monitoring system capable of identifying special event content within said received broadcast content streams, each of said received broadcast content streams having detectable content attributes, said monitoring system operable to (i) sense a content change within at least one of said received broadcast content streams as a function of said detectable content attributes, (ii) detect said special event content broadcast within said at least one of said received broadcast content streams as a function of said sensed content change, and (iii) selectively generate a notification signal as a function of said detected special event content and a subscriber profile.

28. The appliance as set forth in claim 27 wherein said subscriber profile is stored in memory and comprises at least one record that maintains at least one measurable characteristic of an associated subscriber.

29. The appliance as set forth in claim 28 wherein said stored subscriber profile is initially set as a default profile.

30. The appliance as set forth in claim 28 wherein said monitoring system is further operable to update said stored subscriber profile.

31. The appliance as set forth in claim 28 wherein said subscriber profile provides a mathematical representation of a notification preference of an associated subscriber.

32. The appliance as set forth in claim 31 wherein said subscriber profile is automatically generated by said monitoring system at definition and includes a default notification preference that is modifiable by said associated subscriber.

33. The appliance as set forth in claim 32 wherein said monitoring system, as a function of said mathematical representation of said notification preference, generates said notification signal to selectively direct at least one of a plurality of communication units to communicate a message to said associated subscriber.

34. The appliance as set forth in claim 27 wherein said monitoring system is further operable to identify said sensed content change as one of scheduled broadcast content and unscheduled broadcast content that preempts scheduled broadcast content.

35. The appliance set forth in claim 27 wherein said subscriber profile is actively associated therewith.

36. The appliance set forth in claim 27 wherein said subscriber profile is passively associated therewith.

37. The appliance set forth in claim 27 wherein said monitoring system is further operable to monitor at least one of audio content, video content and textual content within said plurality of broadcast content streams.

38. The appliance set forth in claim 37 wherein said monitoring system detects said special event content broadcast within said at least one of said plurality of broadcast content streams as a function of said at least one of audio content, video content and textual content.

39. The appliance set forth in claim 37 wherein ones of said detectable content attributes include a transcript of said at least one of audio content, video content and textual content, and monitoring system detects said special event content broadcast within said at least one of said plurality of broadcast content streams as a function of said transcript.

40. A notification signal selectively generated as a function of detected special event content and a subscriber profile, said notification signal selectively generated by the steps of:
monitoring a plurality of broadcast content streams, each of said plurality of broadcast content streams having detectable content attributes;
sensing a content change within at least one of said plurality of broadcast content streams as a function of said detectable content attributes; and
detecting special event content broadcast within said at least one of said plurality of broadcast content streams as a function of said sensed content change.

41. The selectively generated notification signal as set forth in claim 40 wherein said signal directs operation of an appliance.

42. The selectively generated notification signal as set forth in claim 41 wherein said associated appliance is capable of operating in one of an active mode and a standby mode and, when said appliance is operating in said standby mode, said signal directs said associated appliance to switch from said standby mode to said active mode.
